(19) United States
(12) Patent Application Publication
(10) Pub. No.: US 2014/0369603 A1
(43) Pub. Date: Dec. 18, 2014

(54) DETECTION DEVICE FOR REGION OF INTEREST AND METHOD OF DETECTING REGION OF INTEREST

(71) Applicant: SAMSUNG ELECTRONICS CO., LTD., Suwon-si (KR)

(72) Inventor: Omry Sendik, Tel-Aviv (IL)

(73) Assignee: SAMSUNG ELECTRONICS CO., LTD., Suwon-si (KR)

(21) Appl. No.: 14/192,912

(22) Filed: Feb. 28, 2014

(30) Foreign Application Priority Data
Jun. 12, 2013 (KR) 10-2013-0067226

(51) Int. Cl. G06K 9/46

(52) U.S. Cl. CPC G06K 9/46
USPC 382/195

(57) ABSTRACT

A method of detecting an ROI is provided. The method includes calculating energy of each of unit blocks constituting an image frame, detecting at least one interest block having energy higher than a threshold value among the unit blocks, forming initial ROIs by dividing the image frame, and removing a medium ROI among the initial ROIs.

### CROSS-REFERENCE TO RELATED PATENT APPLICATION

This U.S. patent application claims priority under 35 U.S.C. §119 to Korean Patent Application No. 10-2013-0067226, filed on Jun. 12, 2013, the disclosure of which is incorporated by reference herein.

### TECHNICAL FIELD

The present inventive concept relates to a motion estimation, and more particularly, to a detection device for a region of interest and a method of detecting the same to perform the motion estimation.

### DISCUSSION OF THE RELATED ART

In image processing, estimations of motion vectors are used to estimate how each object of an image frame moves. A motion vector has multi-dimensional information (e.g., two-dimensional information) and expresses a movement of an object between a current image frame and a reference image frame as an amount of movement on a coordinate plane. For example, when a motion vector has two-dimensional information, the motion vector may be constituted by a magnitude of a horizontal directional movement and a magnitude of a vertical directional movement. Thus, a movement between sequential image frames (e.g., a current image frame and a reference image frame) may be extracted using a motion vector.

To detect a motion vector of an object, a specific region on an image frame is set. The specific region is referred to as a region of interest (ROI). A result of the motion estimation may be affected according to how the ROI is set.

### SUMMARY

According to an embodiment of the inventive concept, a method of detecting a region of interest (ROI) is provided. The method includes calculating energy of each of unit blocks constituting an image frame, detecting at least one interest block having energy higher than a threshold value among the unit blocks, forming initial ROIs by dividing the image frame, and removing a medium region among the initial ROIs.

In an embodiment, the step of forming initial ROIs may form initial ROIs having a level n (n≧0, n is an integer) and initial ROIs having a level n+1. The number of the initial ROIs having the level n+1 may be more than the number of the initial ROIs having the level n.

In an embodiment, the number of the initial ROIs having the level n may be 2ⁿ⁺² and the number of the initial ROIs having the level n+1 may be 2ⁿ⁺⁴.

In an embodiment, the step of removing a medium ROI may be performed on the initial ROIs having the level n+1 after a medium ROI among the initial ROIs having the level n is detected.

In an embodiment, the initial ROIs having the level n+1 may correspond to the detected medium ROI among the initial ROIs having the level n.

In an embodiment, the step of removing a medium ROI among the initial ROIs may be performed again on the initial ROIs having the level n remaining after a medium ROI among the initial ROIs having the level n+1 is removed.

In an embodiment, the step of removing a medium ROI among the initial ROIs may be performed until the number of the initial ROIs having the level n+1, remained after the medium ROI is removed, becomes the same as a predetermined number.

In an embodiment, the step of calculating energy of unit blocks constituting an image frame may include removing energy of DC component of the unit blocks.

In an embodiment, the energy may include energy in a first direction and energy in a second direction.

In an embodiment, the first and second directions may be perpendicular to each other.

In an embodiment, the energies in the first and second directions may be calculated on the basis of luminance of each of the unit blocks.

In an embodiment, the step of forming initial ROIs by dividing the image frame may be performed by dividing the image frame in a grid pattern.

According to an embodiment of the inventive concept, a detection device for an ROI is provided. The detection device includes an interest block detection unit and an ROI detection unit. The interest block detection unit is configured to calculate energy of each of unit blocks of an image frame and to detect at least one interest block having energy higher than a threshold value among the unit blocks. The ROI detection unit is configured to detect at least one final ROI by dividing the image frame into initial ROIs, and removing a medium ROI among the initial ROIs. The ROI detection unit is configured to remove the medium ROI among the initial ROIs until the number of final ROIs becomes the same as a predetermined number.

In an embodiment, the interest block detection unit may be configured to calculate energy in a vertical direction and energy in a horizontal direction of each of the unit blocks.

According to an embodiment of the inventive concept, a detection device for an ROI is provided. The detection device includes an interest block detection unit and an ROI detection unit. The interest block detection unit is configured to calculate energy of each of unit blocks of an image frame and to detect at least one interest block having energy higher than a threshold value among the unit blocks. The ROI detection unit is configured to detect at least one final ROI by dividing the image frame to form initial ROIs having a level n (n≧0, n is an integer) and initial ROIs having a level n+1, and removing a medium ROI among the initial ROIs having the level n+1. The level n+1 is the highest level having higher number of the initial ROIs than a predetermined number of final ROIs.

### BRIEF DESCRIPTION OF THE DRAWINGS

Embodiments of the inventive concept will be described in more detail with reference to the accompanying drawings, in which:

FIGS. 1 and 2 are drawings for explaining motion estimation;

FIG. 3 illustrates a general method of detecting an ROI;

FIG. 4 is a block diagram illustrating a detection device for an ROI in accordance with an embodiment of the inventive concept;

FIG. 5 is a flow chart illustrating a method of detecting an ROI in accordance with an embodiment of the inventive concept;

FIGS. 6 through 8 are drawings for explaining steps S110 through S130 of FIG. 5;

FIGS. 9 and 10 are drawings for explaining a step S140 of FIG. 5;

FIG. 11 is a flow chart illustrating another embodiment of the step S140;

FIGS. 12 through 16 illustrate results of applying a method of detecting an ROI in accordance with an embodiment of the inventive concept;

FIG. 17 is a block diagram illustrating a video encoding device in accordance with an embodiment of the inventive concept;

FIG. 18 is a block diagram illustrating an application processor in accordance with an embodiment of the inventive concept; and

FIG. 19 is a block diagram illustrating a mobile device including the application processor of FIG. 18.

### DETAILED DESCRIPTION OF THE EMBODIMENTS

Embodiments of inventive concepts will be described more hereinafter with reference to the accompanying drawings. This inventive concept may, however, be embodied in many different forms and should not be construed as limited to the embodiments set forth herein. Rather, these embodiments are provided so that this disclosure will be thorough and complete, and will fully convey the scope of the inventive concept to those skilled in the art. In the drawings, the size and relative sizes of layers and regions may be exaggerated for clarity. Like numbers may refer to like elements throughout.

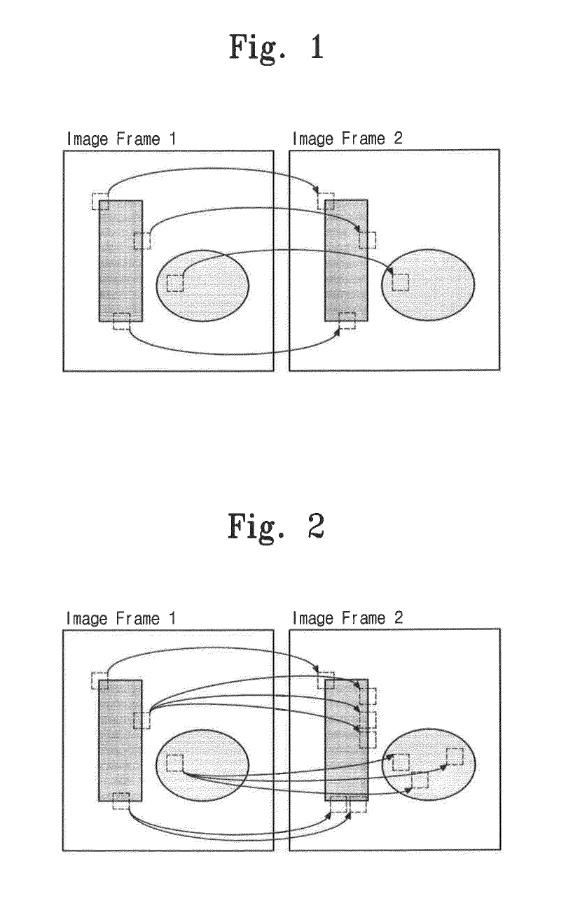

FIGS. 1 and 2 are drawings for explaining motion estimation. First and second image frames may be sequential image frames in time.

Motion estimation estimates locations of objects included in the first image frame on the second image frame. Motion of the objects can be estimated by estimating motion of specific regions constituting the objects. Motion estimation may be understood in a similarity measurement procedure with respect to the specific regions of the first and second image frames. A motion vector estimated through the motion estimation is given as a difference between a coordinate of a specific region of the first image frame and a coordinate of the specific region of the second image frame. To achieve this, setting of an ROI is needed in motion estimation.

Referring to FIGS. 1 and 2, ROIs (i.e., it is marked by a dot line) that are set for motion estimation between the first and second image frames are illustrated. An arrow leading to the second image frame from the first image frame may be understood as roughly illustrating a motion vector. In case of an object having a rectangular shape, an ROI is set at a corner of the object or on a side of the object. In case of an object having an oval shape, an ROI is set inside the object.

Referring to FIG. 2, an ROI which is set at a corner of the object having a rectangular shape provides only one motion vector. An ROI which is set on a side of the object having a rectangular shape may provide two or more motion vectors. Similarly, an ROI that is set inside the object having an oval shape may provide two or more motion vectors. An estimation result of a motion vector with respect to an ROI may be different depending on how the ROI is set.

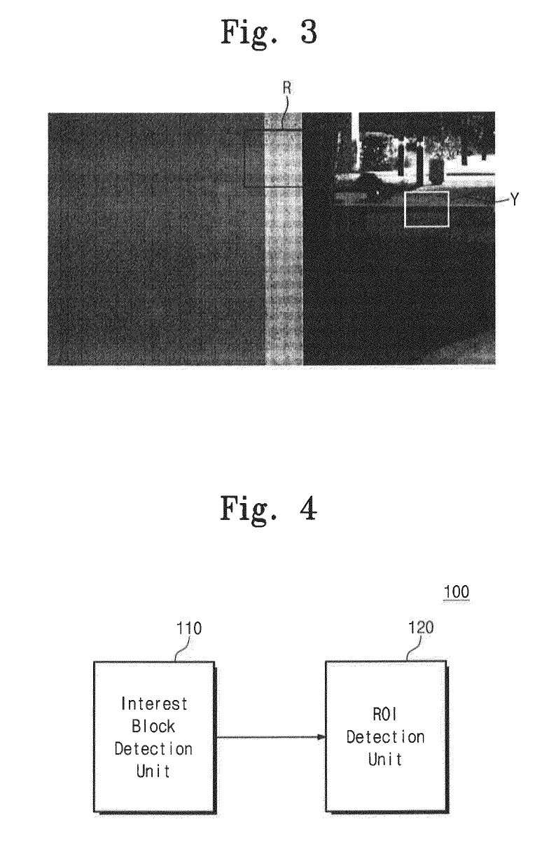

FIG. 3 illustrates a general method of detecting an ROI.

Referring to FIG. 3, an example that an ROI is set in a real image frame is illustrated. ROIs (R, Y) may have two or more motion vectors that describe a motion as mentioned with reference to FIG. 2 like the ROI that is set on a side of the object having a rectangular shape described with reference to FIG. 2. Thus, setting the ROIs (R, Y) might not result in a reliable motion estimation.

FIG. 4 is a block diagram illustrating a detection device for an ROI in accordance with an embodiment of the inventive concept.

Referring to FIG. 4, a detection device 100 for an ROI includes an interest block detection unit 110 and an ROI detection unit 120.

The interest block detection unit 110 may detect an interest block among unit blocks constituting an image frame. To detect the interest block, the interest block detection unit 110 may calculate energy of each of unit blocks constituting the image frame. The energy may be calculated on the basis of intensity or luminance of each of the unit blocks using a mathematical formula 1 below.

Lum=0.29·Red+0.6·Green+0.11·Blue [mathematical formula 1]

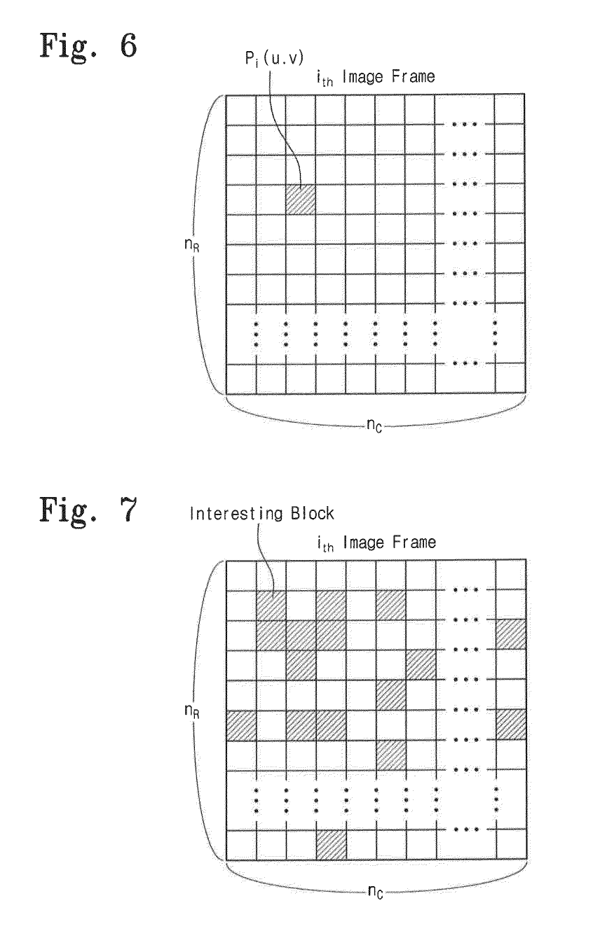

Herein, Lum means luminance of a unit block, and Red, Green, and Blue mean luminances of red-colored, green-colored, and blue-colored lights, respectively. A unit block having higher energy than a threshold value among the unit blocks may be detected as an interest block. Energy of each of unit blocks may include vertical energy and horizontal energy. The threshold value may be predetermined according to an image characteristic (e.g., brightness, chroma, etc.) of an imager frame. An operation of the interest block detection unit 110 will be described in more detail with reference to FIGS. 6 and 7.

The ROI detection unit 120 divides an image frame into a plurality of initial ROIs, processes the divided initial ROIs, and detects one or more final ROIs. For example, the ROI detection unit 120 may detect one or more final ROIs by removing an initial ROI (hereinafter it is referred to as a ‘medium ROI’) that includes the greatest number of interest blocks among the divided initial ROIs. To achieve this, the ROI detection unit 120 divides an image frame to form initial ROIs having a level n (n≧0, n is an integer) and initial ROIs having a level n+1. However, the ROI detection unit 120 may form more initial ROIs (e.g., initial ROIs having a level n+2 and initial ROIs having a level n+3) depending on various configurations of the present invention, and thus, the present inventive concept is not limited thereto.

The number of the initial ROIs having a level n+1 may be more than the number of the initial ROIs having a level n. That is, it may be understood that the initial ROIs having the level n+1 are divided more as compared with the initial ROIs having the level n. For example, the number of the initial ROIs having the level n may be 2ⁿ⁺² and the number of the initial ROIs having the level n+1 may be 2ⁿ⁺⁴.

The ROI detection unit 120 may first detect a first medium ROI among the initial ROIs having a level n, and then may detect a second medium ROI among the initial ROIs having a level n+1. The initial ROIs having the level n+1 corresponds to the first medium ROI detected among the initial ROIs having the level n. For example, if the level n+1 is at the highest level, the ROI detection unit 120 may remove the second medium ROI. The ROI detection unit 120 may repeat the aforementioned procedure with respect to the initial ROIs of the level n pertaining to the second medium ROI. The ROI detection unit 120 may detect and remove the medium ROI until the number of remained final ROIs is equal to a predetermined number.

The ROI detection unit 120 may determine the number of times of division of an image frame (e.g., the number of levels) based on the predetermined number. Depending on the number of times of division of the image frame, the number of levels of initial ROIs to be formed may be determined. The ROI detection unit 120 may divide an image frame to form initial ROIs so that the number of initial ROIs is more than the predetermined number.

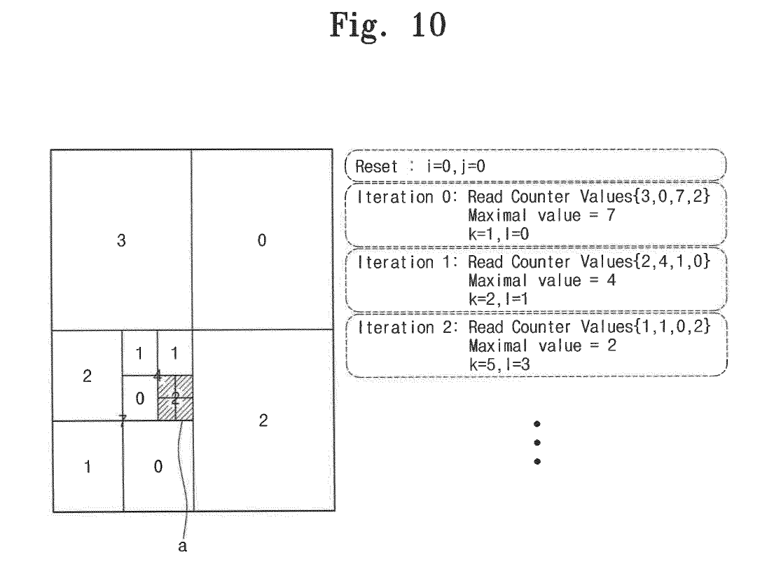

An operation of the ROI detection unit 120 will be described in more detail with reference to FIGS. 9 and 10.

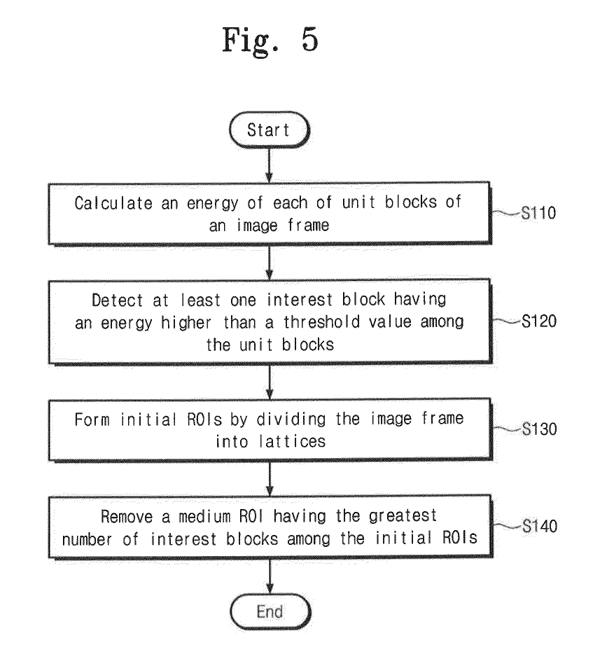

FIG. 5 is a flow chart illustrating a method of detecting an ROI in accordance with an embodiment of the inventive concept. FIGS. 6 through 8 are drawings for explaining steps S110 through S130 of FIG. 5. FIGS. 9 and 10 are drawings for explaining a step S140 of FIG. 5.

Referring to FIG. 5, the method of detecting an ROI in accordance with an embodiment of the inventive concept may include calculating energy of each of unit block of an image frame (S110), detecting at least one interest block having higher energy than a threshold value among the unit blocks (S120), dividing the image frame to form initial ROIs (S130), and removing a medium ROI that includes the greatest number of interest blocks among the initial ROIs (S140).

In the step S110, the interest block detection unit 110 may calculate energy of each of the unit blocks. Referring to FIG. 6, the unit blocks of the image frame are illustrated. The image frame may be constituted by a plurality of unit blocks. The image frame may be constituted by n_{R} number of unit blocks in row and n_{C} number of unit blocks in column.

The interest block detection unit 110 may calculate energy of each of the unit blocks using luminance of the image frame. The luminance of the image frame may be calculated using the mathematical formula 1. The interest block detection unit 110 may calculate energy of each of the unit blocks using mathematical formulas 2 through 7 below. The interest block detection unit 110 may calculate energy in a vertical direction and energy in a horizontal direction of each of the unit blocks.

$$RowSum = \frac{1}{{n}_{R}} {\sum }_{u} {P}_{i} ( u , v ) ≡ {P}_{i}^{R} ( v ) \\ ColSum = \frac{1}{{n}_{C}} {\sum }_{v} {P}_{i} ( u , v ) ≡ {P}_{i}^{C} ( u ) \qquad [ mathematical formula 2 ]$$

Herein, the Pi(u,v) means luminance of a unit block of i-th image frame, and the n_{R} and the n_{c} mean the number of rows and the number of columns in the i-th image frame, respectively. The mathematical formula 2 may be understood that the image frame is projected by the sum of luminance in row and in column to which averages are taken along with the row and column, respectively. Energy in the row and column directions of the image frame may be calculated using a mathematical formula 3 on the basis of the RowSum and ColSum calculated using the mathematical formula 2.

$$Row Energy = {\sum }_{v} {( {P}_{i}^{R} ( v ) )}^{2} \\ Col Energy = {\sum }_{u} {( {P}_{i}^{C} ( u ) )}^{2} \qquad [ mathematical formula 3 ]$$

The mathematical formula 3 may be drawn using the Parseval's theorem. The Row Energy may mean horizontal energy in the image frame. The Col Energy may mean vertical energy in the image frame.

Since energy of DC component among energies of the unit block does not result in strong motion estimation, it may be removed. For example, intensity of DC component may be calculated using mathematical formulas 4 and 5 below.

$$[ mathematical formula 4 ]$$

$$Row Average Intensity = \frac{1}{{n}_{C}} {\sum }_{v} {P}_{i}^{R} ( v )$$

$$Col Average Intensity = \frac{1}{{n}_{R}} {\sum }_{u} {P}_{i}^{C} ( u ) \\ [ mathematical formula 5 ]$$

$$\begin{matrix}Row Average Intensity = Col Average Intensity \\ = \frac{1}{{n}_{R} {n}_{C}} {\sum }_{u , v} {P}_{i} ( u , v ) ≡ μ\end{matrix}$$

Using the mathematical formulas 4 and 5, intensity of DC component in the row and column directions of the image frame may be calculated. Using a mathematical formula 6 below on the basis of the calculated μ value, the interest block detection unit 110 may calculate energy of row and column directions of the image frame from which DC component is removed.

$$[ mathematical formula 6 ]$$

$$High Frequency Horizontal Energy = {\sum }_{v} {( {P}_{i}^{R} ( v ) - μ )}^{2}$$

$$High Frequency Vertical Energy = {\sum }_{u} {( {P}_{i}^{C} ( u ) - μ )}^{2}$$

Herein, High Frequency Horizontal Energy may mean energy of row direction of the image frame from which DC component is removed. High Frequency Vertical Energy may mean energy of column direction of the image frame from which DC component is removed.

On the basis of the RowSum and the ColSum calculated using the mathematical formula 3 and the High Frequency Horizontal Energy and the High Frequency Vertical Energy calculated using the mathematical formula 7, the interest block detection unit 110 may calculate vertical energy and horizontal energy of each of the unit blocks using a mathematical formula 7 below.

$$H E = \frac{{\sum }_{v} {( {P}_{i}^{R} ( v ) - μ )}^{2}}{{\sum }_{v} {( {P}_{i}^{R} ( v ) )}^{2}} \\ V E = \frac{{\sum }_{u} {( {P}_{i}^{C} ( u ) - μ )}^{2}}{{\sum }_{u} {( {P}_{i}^{C} ( u ) )}^{2}} \qquad [ mathematical formula 7 ]$$

Herein, the HE may mean horizontal energy of each of the unit blocks and the VE may mean vertical energy of each of the unit blocks.

In the step S120, the interest block detection unit 110 may detect at least one interest block. In the case that vertical energy and horizontal energy of a unit block are higher than a threshold value, the interest block detection unit 110 may detect the unit block as an interest block. The shaded unit blocks may be an interest block. The interest block may be one or more in an image frame, however the interest block may not be limited to the shaded unit blocks illustrated in FIG. 7.

In the step S130, the ROI detection unit 120 may divide an image frame to form initial ROIs. The ROI detection unit 120 may form initial ROIs having a plurality of levels. The ROI detection unit 120 may set the number of levels according to the predetermined number of ROIs. The ROI detection unit 120 may divide the image frame to form initial ROIs so that a level having a higher number of initial ROIs than a number of final ROIs becomes the highest level. The ROI detection unit 120 evenly divides the image frame in a grid pattern to form the plurality of initial ROIs.

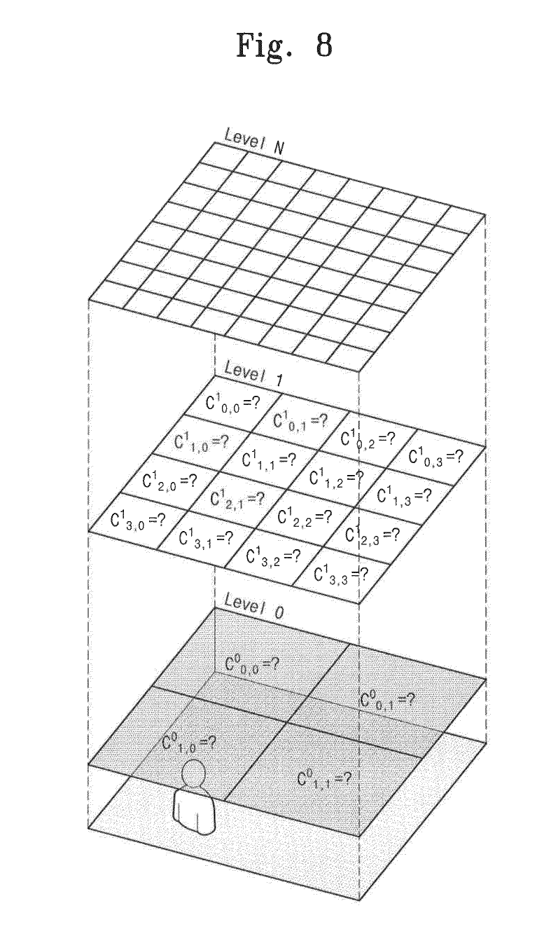

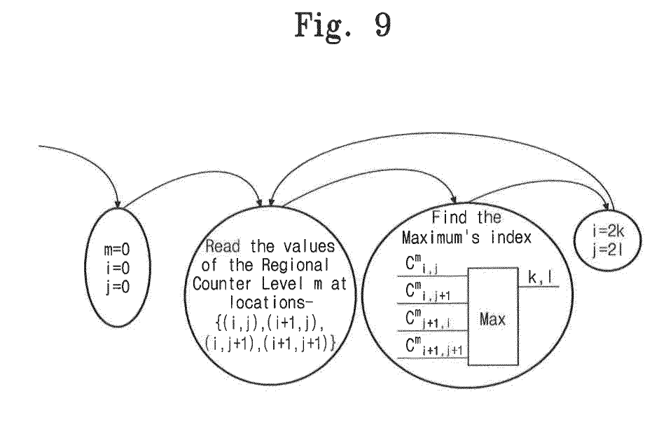

Referring to FIG. 8, the ROI detection unit 120 may divide the image frame to form four initial ROIs having a level 0, sixteen initial ROIs having a level 1, and 2ⁿ⁺² initial ROIs having a level n. However, the number of initial ROIs according to each level may not be limited thereto. Initial ROIs of each level may correspond to each other. For example, initial ROIs of C¹_{2,0}, C¹_{2,1}, C¹_{3,0}, and C¹_{3,1} of the level 1 may correspond to an initial ROI of C⁰_{1,0} of the level “0”.

In the step S140, the ROI detection unit 120 may detect a final ROI by removing a medium ROI among the initial ROIs. The number of the final ROIs may be previously set.

Referring to FIG. 9, the ROI detection unit 120 may detect a medium ROI among initial ROIs at coordinates of (i,j), (i+1,j), (i,j+1), (i+1,j+1) having a level m. The m may mean a level of initial ROIs. The i and j may mean coordinates of an initial ROI, respectively. The m, i, and j may be set to be 0 at the initial stage.

The ROI detection unit 120 may detect a medium ROI that includes the greatest number of interest blocks among initial ROIs having the level 0. The ROI detection unit 120 may double (e.g., i=2k, j=2l) coordinate values (e.g., k, l) of a medium ROI detected among initial ROIs having the level 0. In an aspect, the ROI detection unit 120 may be understood as detecting a medium ROI with respect to initial ROIs having the level 1 corresponding to the medium ROI detected among the initial ROIs having the level 0. The ROI detection unit 120 may detect a medium ROI among initial ROIs of a next level (e.g., a level 1).

The ROI detection unit 120 may detect medium ROIs with respect to initial ROIs having the highest level formed while repeating the procedure described above. The ROI detection unit 120 may remove the medium ROIs detected among the initial ROIs having the highest level. The ROI detection unit 120 may reset m, i, j to detect a medium ROI again from the level 0 with respect to the rest of initial ROIs. That operation of the ROI detection unit 120 may be repeated until the number of remained final ROIs equal to a predetermined number.

Referring to FIG. 10, detailed procedures of detecting and removing medium ROIs among initial ROIs having multiple levels is illustrated. For convenience of description in FIG. 10, it is assumed that an image frame is divided into initial ROIs having three levels (e.g., level 0, level 1, and level 2).

The ROI detection unit 120 detects a medium ROI among initial ROIs having the level 0. The ROI detection unit 120 may detect a medium ROI that includes the greatest number of interest blocks (e.g., 7) at a coordinate of (1, 0) of the level 0. The ROI detection unit 120 doubles coordinate values of the detected medium ROI to detect a medium ROI among initial ROIs having the level 1. The ROI detection unit 120 may detect a medium ROI with respect to initial ROIs at coordinates of (2, 0), (2, 1), (3, 0), (3, 1) among initial ROIs having a level 1. As a result, the ROI detection unit 120 may detect a medium ROI including the greatest number of interest blocks (e.g., 4) at a coordinate of (2, 1) of the level 1. The ROI detection unit 120 may detect a medium ROI with respect to initial ROIs having coordinates of (4, 2), (4, 3), (5, 2), (5, 3) among initial ROIs having a level 2. As a result, the ROI detection unit 120 may detect a medium ROI (a) including the greatest number of interest blocks (e.g., 2) at a coordinate (5, 3) of the level 2.

The ROI detection unit 120 may remove the medium ROI (a) detected among the initial ROIs having a level 2. The ROI detection unit 120 may repeat detecting a medium ROI from the level 0 with respect to the initial ROIs remained without being removed.

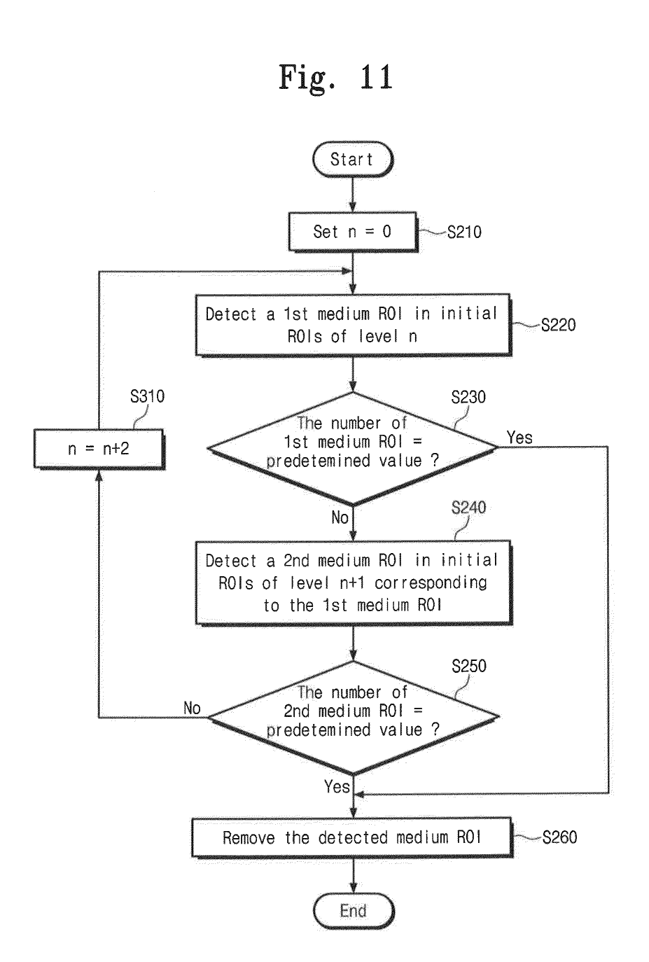

FIG. 11 is a flow chart illustrating an embodiment of the step S140.

Referring to FIG. 11, unlike the embodiments illustrated in FIGS. 9 and 10, the ROI detection unit 120 may repeat detecting and removing medium ROIs until the number of medium ROIs being removed becomes the same as a predetermined value. For convenience of description, it is assumed that a level into which an image frame is divided is determined according to the predetermined number of medium ROIs.

At the initial stage, a level (n) of initial ROIs may be set to be 0 (S210). The ROI detection unit 120 may detect a first medium ROI among initial ROIs having a level n (S220).

The ROI detection unit 120 judges whether the number of the detected first medium ROIs is the same as the predetermined value (S230). In the case that the number of the detected first medium ROIs is not the same as the predetermined value, the ROI detection unit 120 may detect a second medium ROI with respect to initial ROIs having a level n+1 that correspond to the first medium ROI. In the case that the number of the detected first medium ROIs is the same as the predetermined value, the ROI detection unit 120 removes the detected first medium ROI and detects a final ROI (S260).

The ROI detection unit 120 judges whether the number of the detected second medium ROIs is the same as the predetermined value (S250). In the case that the number of the detected second medium ROIs is not the same as the predetermined value, the ROI detection unit 120 sets an n value to n+2 to perform an operation of the step S220 again (S310). In the case that the number of the detected second medium ROIs is the same as the predetermined value, the ROI detection unit 120 removes the detected second medium ROI and detects a final ROI (S260).

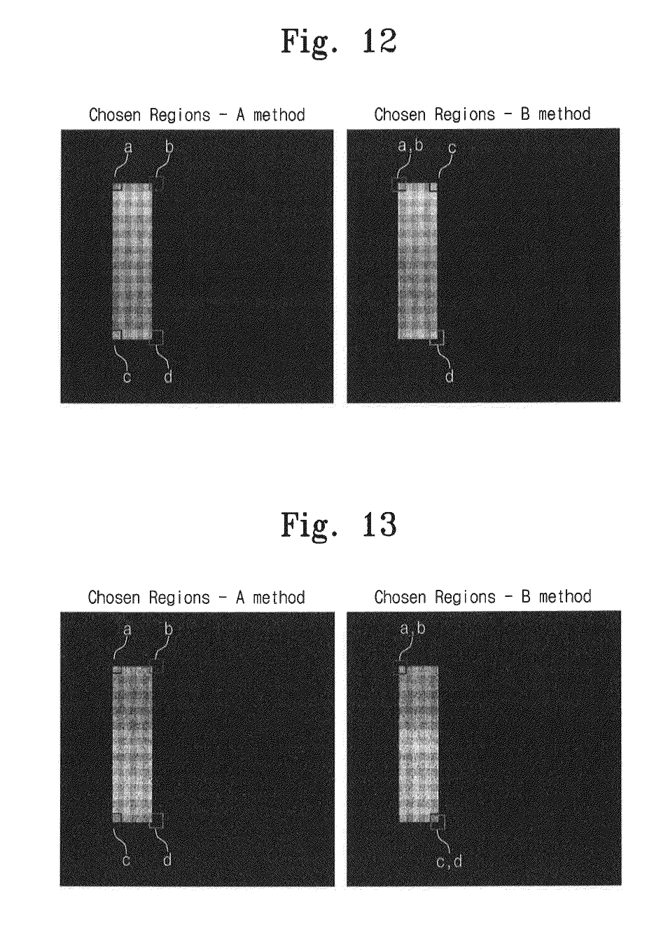

FIGS. 12 through 16 illustrate results of applying methods of detecting ROIs in accordance with embodiments of the inventive concept.

A Harris Corner Detection method (hereinafter it is called ‘B’ method) may be used for extracting a characteristic point of an image.

Referring to FIG. 12, a case where the number of final ROIs is set to be four is illustrated. In a case that a method of detecting a ROI (hereinafter it is called ‘A’ method) in accordance with an embodiment of the inventive concept is used, final ROIs (a, b, c, d) are evenly set at corners of an object having a rectangular shape, respectively. In a case of the B method, final ROIs are set at corners of an object having a rectangular shape, however two final ROIs (a, b) overlap each other and thereby three final ROIs are set.

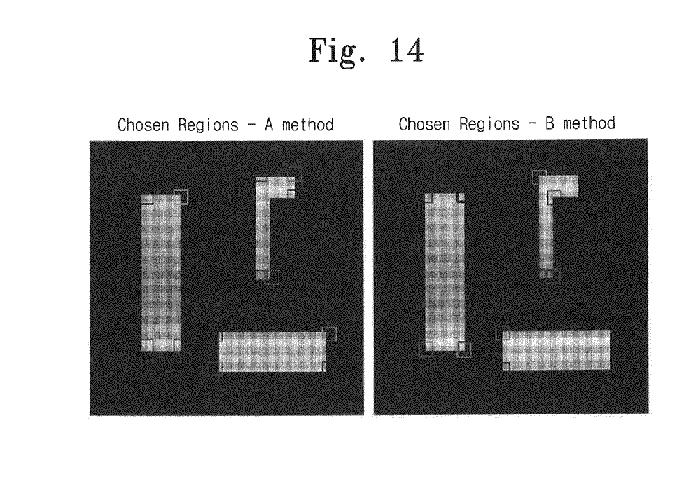

Referring to FIG. 13, a case where the number of final ROIs is set to be four and noise exists is illustrated. In a case of the A method, although noise exists, final ROIs (a, b, c, d) are evenly set at corners of an object having a rectangular shape, respectively. In a case of the B method, some final ROIs overlap each other and thereby two final ROIs (a, b and c, d) are set.

Referring to FIG. 14, a case where the number of final ROI is set to be thirteen is illustrated. Although the number of final ROIs increases as compared with the case of FIG. 12, in a case of the A method, final ROIs are evenly set at corners of an object. In a case of the B method, some final ROIs overlap each other and thereby ten final ROIs are set. Although the number of final ROIs is increased (e.g., the number of objects an image frame is increased), the A method may result in an accurate ROI detection.

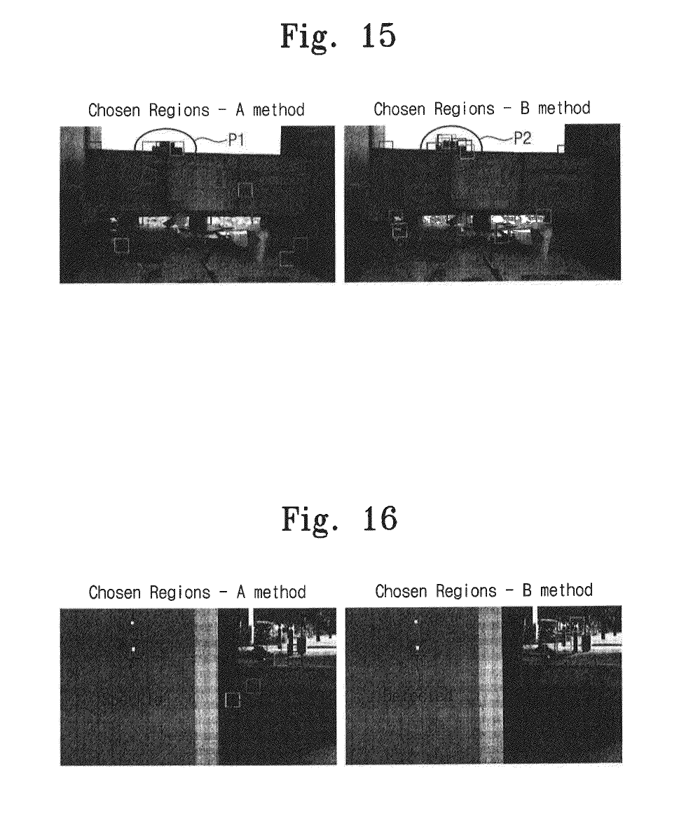

Referring to FIG. 15, a result of detecting ROI detection on a real image frame is illustrated. The number of final ROIs is set to be 25. In a case of the A method, a final ROI with respect to P1 region is evenly distributed. In a case of the B method, final ROIs with respect to P2 region corresponding to the P1 region overlap each other. In a case of the B method, final ROIs overlap each other with respect to other objects on an image frame.

Referring to FIG. 16, a case where ten ROIs are set with respect to a real image frame and an effect due to a speckle exists is illustrated. In a case of the A method, an effect due to a speckle does not exist and ten final ROIs are evenly set with respect to objects on the real image frame. However, in a case of the B method, because of an effect due to a speckle, a final ROI is set on the speckle. Also, some final ROIs overlap each other with respect to objects on the real image frame.

As described above, the detection device for an ROI and the method of detecting an ROI in accordance with an embodiment of the inventive concept result in an accurate detection of ROIs even when noise and/or a speckle exist. Even in the case that a lot of objects exist on an image frame, the detection device for an ROI and the method of detecting an ROI may contribute to accurate motion estimation by evenly setting final ROIs. The detection device for an ROI and the method of detecting an ROI in accordance with an embodiment of the inventive concept may be used in a video encoding device that needs motion estimation.

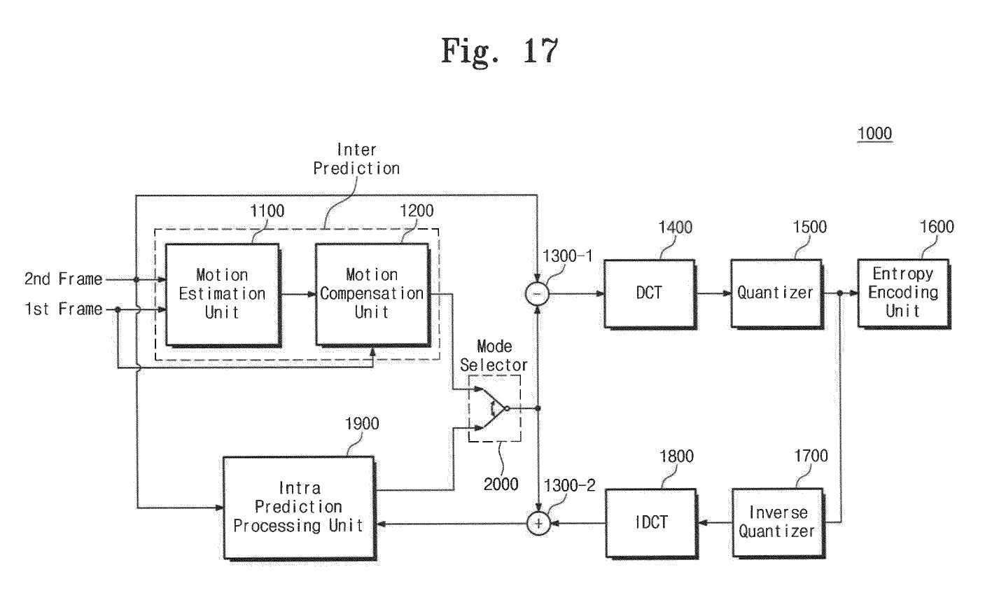

FIG. 17 is a block diagram illustrating a video encoding device in accordance with an embodiment of the inventive concept.

Referring to FIG. 17, the video encoding device 1000 in accordance with an embodiment of the inventive concept may include a motion estimation unit 1100, a motion compensation unit 1200, a substractor 1300-1, an adder 1300-2, a discrete cosine transformation (DCT) 1400, a quantizer 1500, an entropy encoding unit 1600, an inverse quantizer 1700, an inverse DCT (IDCT) 1800, an intra prediction processing unit 1900, and a mode selector 2000.

The video encoding device 1000 may operate as an inter prediction mode or an intra prediction mode according to a control of the mode selector 2000.

The motion estimation unit 1100 may include the detection device 100 for an ROI illustrated in FIG. 4. The motion estimation unit 1100 may detect an ROI and may estimate a motion vector about the detected ROI.

The motion compensation unit 1200 performs motion compensation on a first frame using the motion vector that is transmitted from the motion estimation unit 1100 and transmits the motion compensated frame to the subtractor 1300-1.

The subtractor 1300-1 receives the motion compensated frame and a second frame to generate a differential frame between the motion compensated frame and the second frame.

The DCT 1400 performs a discrete cosine transformation on the differential frame between the motion compensated frame and the second frame, and generates a DCT coefficient. The DCT 1400 transmits the generated DCT coefficient to the quantizer 1500.

The quantizer 1500 quantizes the DCT coefficient transmitted from the DCT 1400 and transmits to the entropy encoding unit 1600 and the inverse quantizer 1700.

The entropy encoding unit 1600 may encode the quantized DCT coefficient to generate an encoded output bit stream. The entropy encoding unit 1600 may use an arithmetic coding, a variable length coding, a Huffman coding, or the like to generate the encoded output bit stream.

The inverse quantizer 1700 may perform an inverse-quantization on the quantized DCT coefficient.

The IDCT 1800 performs an inverse discrete cosine transformation on the DCT coefficient that is transmitted from the inverse quantizer 1700, and transmits the inversely discrete cosine transformed DCT coefficient to the intra processing unit 1900 through adder 1300-2.

The intra predicting processing unit 1900 generates an output frame using the second frame shot from an image sensor (not shown) and an inversely discrete cosine transformed DCT coefficient that is transmitted from the IDCT 1800. The output frame generated by the intra prediction processing unit 1900 does not include a motion compensation unlike an inter prediction unit including the motion estimator 1100 and the motion compensation unit 1200.

The adder 1300-2 may receive the output frame of the intra prediction processing unit and may generate an added result of the output of the intra prediction processing unit and the output of the inverse discrete cosine transforming unit. The added output of the adder 1300-2 may be an input to the intra prediction processing unit.

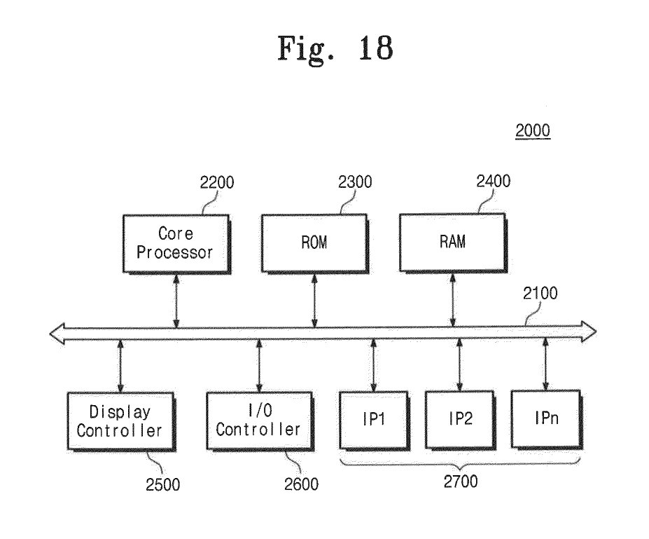

FIG. 18 is a block diagram illustrating an application processor in accordance with an embodiment of the inventive concept.

Referring to FIG. 18, the application processor 2000 in accordance with an embodiment of the inventive concept may include an internal bus 2100, a core processor 2200, a ROM 2300, a RAM 2400, a display controller 2500, an I/O controller 2600, and a plurality of IPs 2700.

The internal bus 2100 provides a channel between constituent elements of the application processor 2000.

The core processor 2200 may control constituent elements of the application processor 2000 and may perform various logical operations.

The ROM 2300 may store code data (e.g., a boot code for booting) for an operation of the core processor 2200.

The random access memory (RAM) 2400 may be used as an operation memory of the core processor 2200. The RAM 2400 may include at least one of random access memories such as a dynamic random-access memory (DRAM), a synchronous dynamic random-access memory (SRAM), a phase-changed random-access memory (PRAM), a magnetoresistive random-access memory (MRAM), a RRAM, a ferroelectric random-access memory (FRAM), etc.

The display controller 2500 may control connections between display devices (e.g., an LCD, an AMOLED, etc.) and operations thereof.

The I/O controller 2600 may control connections between input/output devices (e.g., a mouse, a keyboard, a printer, network interface devices, etc).

The plurality of IPs (IP1, IP2 and IPn, n is a natural number) 2700 may include a direct memory access (DMA), an image processor (ISP), etc. The IP1 among the IPs 2700 may include the detection device 100 for an ROI described with reference to FIG. 4.

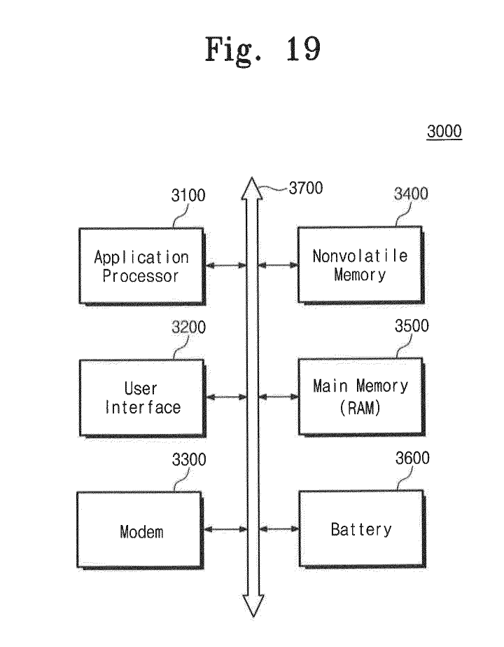

FIG. 19 is a block diagram illustrating a mobile device including the application processor of FIG. 18.

Referring to FIG. 19, the mobile device 3000 may include an application processor 3100, a user interface 3200, a modem 3300, a nonvolatile memory 3400, a main memory 3500, a battery 3600, and a system bus 3700.

The system bus 3700 provides a channel between constituent elements of the mobile device 3000.

The application processor 3100 may be a main processor of the mobile device 3000. The application processor 3100 may control constituent elements of the mobile device 3000, may execute an operating system and applications, and may perform a logical operation. The application processor 3100 may be a system on chip. The application processor 3100 may be constituted in the same manner as the application processor 2000 described with reference to FIG. 11.

The user interface 3200 may exchange a signal with a user. The user interface 3200 may include user input interfaces such as a camera, a microphone, a keyboard, a mouse, a touch pad, a touch panel, a touch screen, a button, a switch, etc. The user interface 3200 may include user output interfaces such as a display device, a speaker, a ramp, a motor, etc. The display device may include an LCD, an AMOLED, a beam projector, etc.

The modem 3300 may communicate with an external device through a wired or wireless channel. The modem 3300 may communicate with an external device on the basis of various communication methods such as LTE, CDMA, GSM, WiFi, WiMax, NFC, Bluetooth, RFID, etc.

The nonvolatile memory 3400 may store data that needs long-term preservation in the mobile device 3000. The storage 3400 may include at least one of nonvolatile memories such as a flash memory, a MRAM, a PRAM, a RRAM, a FRAM, a hard disk drive, etc.

The main memory 3500 may be an operation memory of the mobile device 3000. The main memory 3500 may include at least one of random access memories such as a DRAM, a SRAM, a MRAM, a PRAM, a RRAM, a FRAM, etc.

The battery 3600 can supply an operation power supply to the mobile device 3000.

The method of detecting an ROI in accordance with an embodiment of the inventive concept may be realized in a program command type performed through various computers. The program command may be recorded in a medium and may be decoded by the computers.

Examples of recording medium that may be decoded by the computers include a magnetic media such as a hard disk, a floppy disk, and a magnetic tape, an optical recoding media such as a CD-ROM and a DVD, a magneto-optical media such as a floptical media and a hardware device (e.g., ROM, a RAM, and a flash memory) that is configured to store a program command and to perform the same. For example, the program command may include not only a machine code made by a compiler but also a high level language code that may be executed by a computer using an interpreter. The hardware device may be configured to operate as one or more software modules to perform an operation of the inventive concept, and vice versa.

The above-disclosed subject matter is to be considered illustrative, and not restrictive, and the appended claims are intended to cover all such modifications, enhancements, and other embodiments, which fall within the true spirit and scope of the inventive concept. Thus, to the maximum extent allowed by law, the scope of the inventive concept is to be determined by the broadest permissible interpretation of the following claims and their equivalents, and shall not be restricted or limited by the foregoing detailed description.

What is claimed is:

1. A method of detecting a region of interest (ROI) comprising:
calculating energy of each of unit blocks constituting an image frame;
detecting at least one interest block having energy higher than a threshold value among the unit blocks;
forming initial ROIs by dividing the image frame; and
removing a medium ROI among the initial ROIs.

2. The method of claim 1, wherein the step of forming initial ROIs forms initial ROIs having a level n (n≧0, n is an integer) and initial ROIs having a level n+1, and
wherein the number of the initial ROIs having the level n+1 is more than the number of the initial ROIs having the level n.

3. The method of claim 2, wherein the number of the initial ROIs having the level n is 2ⁿ⁺² and the number of the initial ROIs having the level n+1 is 2ⁿ⁺⁴.

4. The method of claim 2, wherein the step of removing a medium ROI is performed on the initial ROIs having the level n+1 after a medium ROI among the initial ROIs having the level n is detected.

5. The method of claim 4,
wherein the initial ROIs having the level n+1 correspond to the detected medium ROI among the initial ROIs having the level n.

6. The method of claim 4, wherein the step of removing a medium ROI is performed again on the initial ROIs having the level n remaining after a medium ROI among the initial ROIs having the level n+1 is removed.

7. The method of claim 6, wherein the step of removing a medium ROI is performed until the number of the initial ROIs having the level n+1, remained after the medium ROI is removed, becomes the same as a predetermined number.

8. The method of claim 1, wherein the step of calculating energy of each of unit blocks comprises removing energy of DC component of the unit blocks.

9. The method of claim 1, wherein the energy comprises energy in a first direction and energy in a second direction.

10. The method of claim 9, wherein the first and second directions are perpendicular to each other.

11. The method of claim 10, wherein the energies in the first and second directions are calculated on the basis of luminance of each of the unit blocks.

12. The method of claim 1, wherein the step of forming initial ROIs is performed by dividing the image frame in a grid pattern.

13. A detection device for a region of interest (ROI) comprising:
an interest block detection unit configured to calculate energy of each of unit blocks of an image frame and to detect at least one interest block having energy higher than a threshold value among the unit blocks; and
an ROI detection unit configured to detect at least one final ROI by dividing the image frame into initial ROIs and removing a medium ROI among the initial ROIs,
wherein the ROI detection unit configured to remove the medium ROI among the initial ROIs until the number of final ROIs becomes the same as a predetermined number.

14. The detection device of claim 13, wherein the interest block detection unit is configured to calculate energy in a vertical direction and energy in a horizontal direction of each of the unit blocks.

15. The detection device of claim 13, wherein the ROI detection unit is configured to divide the image frame to form initial ROIs having a level n (n≧0, n is an integer) and initial ROIs having a level n+1, and to remove a medium ROI among the initial ROIs having the level n+1, and
wherein the initial ROIs having the level n+1 correspond to a medium ROI among the initial ROIs having the level n.

16. A detection device for a region of interest (ROI) comprising:
an interest block detection unit configured to calculate energy of each of unit blocks of an image frame and to detect at least one interest block having energy higher than a threshold value among the unit blocks; and
an ROI detection unit configured to detect at least one final ROI by dividing the image frame to form initial ROIs having a level n (n≧0, n is an integer) and initial ROIs having a level n+1, and removing a medium ROI among the initial ROIs having the level n+1,
wherein the level n+1 is the highest level having higher number of the initial ROIs than a number of final ROIs.

17. The detection device of claim 16, wherein the initial ROIs having the level n+1 correspond to a medium ROI among the initial ROIs having the level n.

18. The detection device of claim 16, wherein the number of initial ROIs having the level n+1 is more than the number of initial ROIs having the level n.

19. The detection device of claim 18, wherein the number of the initial ROIs having the level n is 2ⁿ⁺² and the number of the initial ROIs having the level n+1 is 2ⁿ⁺⁴.

20. The detection device of claim 16, wherein the removing of the medium ROI among the initial ROIs having the level n+1 is performed after a medium ROI among the initial ROIs having the level n is detected.
